(19) United States
(12) Patent Application Publication
(10) Pub. No.: US 2018/0218338 A1
(43) Pub. Date: Aug. 2, 2018

(54) METHOD AND COMPUTER FOR SCHEDULING CUSTOMER APPOINTMENTS

(71) Applicant: Siemens Healthcare GmbH, Erlangen (DE)

(72) Inventors: Arne Hengerer, Moehrendorf (DE); Lars Lauer, Neunkirchen (DE); Eva Rothgang, Schwaig bei Nuernberg (DE); Rainer Schneider, Erlangen (DE)

(73) Assignee: Siemens Healthcare GmbH, Erlangen (DE)

(21) Appl. No.: 15/881,487

(22) Filed: Jan. 26, 2018

(30) Foreign Application Priority Data
Jan. 27, 2017 (DE) 102017201333.8

(51) Int. Cl. G06Q 10/10; G06Q 50/26; G06F 17/30

(52) U.S. Cl. CPC G06Q 10/1095; H04W 4/02; G06F 17/30528; G06Q 50/26

(57) ABSTRACT

In a computer-implemented method for scheduling customer appointments in one or more service centers, wherein at least some of the customers was a mobile device having a location tracking function and a message transmission function, a central appointments scheduling system manages customer appointments, which has assigned an available time window to at least one customer. A default of a customer appointment of a first customer is recorded. The position of at least one second customer, whose available time window overlaps with the defaulted customer appointment, is detected through the use of the location tracking function of the mobile device and communication of the position to the central appointments scheduling system. The expected travel time of the second customer to the service center is calculated and, if the travel time is shorter than the time remaining up to the start time of the defaulted appointment, an offer is sent to the second customer to accept the defaulted appointment. The defaulted customer appointment is given to the second customer upon acceptance by the second customer.

### BACKGROUND OF THE INVENTION

### Field of the Invention

The invention concerns a method, in particular a computer-implemented method, for scheduling customer appointments in one or more service centers, as well as a corresponding computer and a non-transitory, computer-readable storage medium encoded with programming instructions for implementing such a method.

### Description of the Prior Art

In medical institutions such as hospitals and radiological practices and departments, very expensive equipment is used, for example magnetic resonance tomography systems, radiation therapy machines, computed tomography systems, etc. Substantial losses in the utilization of their capacity are caused as a result of patients not arriving on time or failing to show at all. There are sometimes considerable differences between medical institutions in terms of their patient throughput rates, and the productivity results achieved therewith, depending on how successful they are in avoiding or minimizing patient no-shows or late-shows.

Call centers are often used for this purpose in the prior art, whereby call center staff refer to an electronically administered appointments diary in order to telephone patients to reschedule appointments, arrange new appointments, and remind patients of existing appointments. However, this is very time-consuming, and therefore costly and demanding in terms of human resources. Furthermore, no-shows and late-shows may still occur, with the result that in order to guarantee proper utilization of their capacity, medical institutions leave patients sitting for long periods in the waiting room. This is perceived by an increasing number of patients as unacceptable.

### SUMMARY OF THE INVENTION

An object of the invention is to provide an improved and automated method for scheduling customer appointments in one or more service centers, which enables a good utilization of capacity or a high customer or patient throughput, as well as reducing waiting times for individual customers or patients to a minimum.

Since the method according to the invention can be used both for appointments scheduling in medical (e.g. radiological) institutions and for non-medical service centers (e.g. tax consultancy, law firm, solicitors' practice), the term “customer” is used in the following both for the recipients of a service (e.g. a consulting service in the case of an attorney, tax consultant, architect, etc.) and for patients (both inpatients and outpatients). A “customer appointment” is accordingly an appointment in a medical institution, e.g. an appointment for a magnetic resonance (MR) examination, radiation treatment, computed tomography, physiotherapy, etc., or an appointment in a non-medical service center such as a tax consultancy.

The invention is based on the integration of customers/patients in the appointments scheduling process via their mobile devices, in particular via a smartphone app. An appropriate smartphone app may be provided via the usual sales channels, for example AppStore from Apple, etc.

In embodiments, the mobile device may be any conceivable portable device that is suitable for data communication and/or position determination (location tracking function). In particular, such a device is a smartphone, a cellular telephone, a tablet computer, a notebook or a pager. In advantageous embodiments, different customers can use different mobile devices. In particular, the cited smartphone app may also be executable on a notebook or a tablet.

The appointments for one or more service centers are managed in a central appointments scheduling system having an appointments database. These appointments can either be scheduled in the conventional manner, i.e. by arrangement over the telephone and entry by service center staff. They can also be entered into the central appointments scheduling system by the patients themselves, e.g. via an online access.

Instead of or in addition to the actual appointment, which has a start time and a (generally service-specific) appointment duration, at least some customers specify an available time window in which the customer is available for an appointment. Typically, the time window is much larger than the duration of the appointment, possibly amounting to between two and ten hours per day, for example. If an appointment is arranged for a particular patient, the available time window preferably extends up to a point before the start time of the appointment. It is also possible that customers do not have a fixed appointment at all, but simply enter an available time window; these customers are placed on a standby list, as described in more detail herein below.

In embodiments, the available time window can be specified online by the customers, for example via an internet browser or a software application, in particular a mobile app, which can be activated on a mobile device.

Within the available time window, the customer can be notified automatically by the central appointments scheduling system about appointments that become free on the spur of the moment and can accept these after corresponding confirmation. Specifically, this happens as follows:

The central appointments scheduling system records a default on or delay to a scheduled customer appointment for a first customer, where the appointment lies in the future, typically within the next 1-3 hours, though possibly also 1-5 days in advance.

In the event of a default on a pending customer appointment, the central appointments scheduling system conducts a search for stand-in customers who are able to keep the appointment that has now become free. According to the invention, the position or location of other patients who have specified corresponding available time windows in the central appointments scheduling system is identified for this purpose. This can happen in particular via a smartphone app that determines the location of the customer e.g. via GPS and/or WLAN and communicates the location to the central appointments scheduling system via the smartphone connection. The position of such second customers is determined whose available time window overlaps, such as complete overlaps, with the defaulted (now free) customer appointment.

From the position of the at least one second customer, the system calculates the expected travel time of the second customer to the service center in which the missed appointment was to take place. This can be determined e.g. via a further app on the mobile device, e.g. Google Maps, or by a route planner functionality of the central appointments scheduling system or of the computer on which the latter is hosted. In preferred embodiments, the volume of traffic on the route from the customer to the service center is also taken into account for this purpose.

If the thus estimated travel time of the second customer is shorter than the time remaining up to the start time of the defaulted appointment, or at least is only up to 5 or 10 minutes longer, a message is sent to the second customer with the offer to take the appointment that has become free. The second patient can confirm this offer, via the mobile app for example, whereupon the defaulted appointment is allocated to the second customer. In preferred embodiments, if several customers are within range and are able to keep the new appointment, these are asked in turn, wherein the order of asking can take into account, for example, the calculated travel time, the “buffer time”, which results from the difference between the travel time and the time remaining up to the start time of the free appointment, and/or the ordering criteria cited further below.

In preferred embodiments, the central appointments scheduling system is hosted on a stationary computer, for example a computer, PC, server or the like having a CPU and a data storage means. This computer may be installed in a service center whose appointments are administered, though it may also be a server in the cloud, or a mobile computer such as a laptop, tablet computer or notebook. In preferred embodiments, personal customer data, insofar as this is transferred to the central appointments scheduling system, is encrypted or protected in some other way for the transmission.

In order to establish whether a particular scheduled appointment will be missed, the following steps are preferably performed; in embodiments, these are performed automatically a defined length of time (for example 30 minutes to 1 hour) before each customer appointment. The position of the first customer who is intended to keep the appointment is determined through the use of the location tracking function (e.g. GPS) of the mobile device and communication of the position to the central appointments scheduling system, for example over a mobile communications link. The likely travel time of the first customer to the service center in which the scheduled appointment is to take place is calculated as described above. The expected travel time is compared with the time remaining up to the start time of the customer appointment and, if the travel time exceeds the remaining time, in particular considerably (e.g. by more than 5-20 minutes), the appointment is flagged as delayed or defaulted and is allocated to a second customer in the above-described manner. Alternatively, the appointment is considered to be released only when the customer has been notified via his/her mobile device and has confirmed his/her position and/or his/her unavailability for the scheduled appointment. Thus, if a late-show is indicated by an extrapolation of the estimated, location-dependent travel time of the first patient, the appointment is deferred automatically or, alternatively, following confirmation of the determined location by the patient.

In a preferred embodiment, the central appointments scheduling system in this case searches for a new, later appointment for the first patient, and offers this to the first customer, in particular by means of an automatic message transmission to the mobile device. The first customer can confirm the new appointment directly from his/her mobile device, and the confirmation is forwarded to the central appointments scheduling system, whereupon the appointment is entered and thus included in the scheduling.

In preferred embodiments, the appointments in the appointments database of the appointments scheduling system have at least two different status options, in particular “free”, “offered” and/or “confirmed”. An appointment is free if no appointment at all has yet been recorded in the central appointments scheduling system at said moment in time, or if this has become free due to a late arrival or cancelation by a patient (possibly recorded in the above-described manner). The time window is assigned the status “offered” when this has been offered to a patient, such as automatically or online or by transmission to the mobile device, but the patient has not yet confirmed the appointment. An appointment is not assigned the status “confirmed” until a customer has confirmed the appointment, in particular online, or by an input on the mobile device, in particular in a mobile app, or also by telephone.

In an embodiment, at a predetermined time prior to each appointment, a reminder is sent to the customer in question, in particular to the mobile device, for example by means of a message on the mobile app. However, this can also be a message sent by SMS or WhatsApp or the like. It can furthermore be provided that in said message the patient is requested to (re-) confirm the appointment. For appointments confirmed at short notice like this, a further status “just confirmed” can also be assigned where appropriate. In this way the central appointments scheduling system or the staff at the service center reception desk can assume that the customers in question have at any rate not forgotten the appointment and are likely to show.

In a preferred embodiment, customers also have the option personally, either online or via the mobile app, to reschedule a planned appointment to a slot that is still flagged as free or to arrange new appointments.

It is furthermore advantageous for the appointments stored in the central appointments scheduling system to also contain further information about the type of appointment, in particular parameters that provide information about the likely length and, in the case of radiology appointments, the type of examination. This permits the scheduled duration of each appointment to be specified. In addition, it may be useful, for example in order to optimize patient workflow in the case of magnetic resonance examinations, to process similar examinations/appointments immediately after one another. In the case of magnetic resonance examinations, the replacement of coils, for example, and consequently the “dead time” between individual examinations, can be minimized in this way. It may also make sense for other types of medical examination appointments/treatment appointments to schedule similar appointments one after another. According to a preferred embodiment, if an appointment is missed, only such second customers are contacted (according to the inventive steps above) who satisfy the same parameters (“ordering parameters”) as the appointments taking place before and after the missed appointment. Only if such customers are not available is a check carried out to determine the availability of other customers with other types of appointments whose parameters do not satisfy the ordering parameters.

The method according to the invention can also be used to manage the appointments of a number of service centers. It is useful if at least some of the appointments can optionally take place either in one or another service center. The utilization of the service centers can be optimized further in this way, since the customers can be assigned to the one or the other center in their region. This is particularly advantageous for example for radiological practices having several branches. In particular, customers who have an appointment at a specific time in a first service center can be asked at short notice via a message to their mobile device whether they are also able to keep an appointment in a second service center—in particular at a similar time or possibly also before their scheduled appointment—if a slot has become available at short notice at said second center.

According to another embodiment, the computer determines, at a fixed point in time ahead of each customer appointment, the position of the customer in question and sends to the latter's mobile device directions to the service center in which the appointment is to take place, in particular directions based on his/her position. This can be particularly advantageous for appointments in hospitals, in which typically it is difficult for patients to find their way around. When the patient then enters the hospital, 5-15 minutes before the scheduled appointment for example, suitable directions, e.g. to the radiology department, the magnetic resonance tomography suite, the reception desk and/or the waiting area, are forwarded to him/her.

In other embodiments, the position of customers having appointments scheduled in the appointments scheduling system is constantly polled so that at least some of the above-described actions can be triggered by a specific position. In particular, the directions can be transmitted for example when the patient is less than a certain distance from the service center or, for example, when the patient's mobile device signs into the WLAN of the service center or the hospital in question.

In another embodiment, at least some customers, in particular inpatients in a hospital, have a mobile device issued by the service center. This can be a device embodied specifically for the patient navigation method according to the invention, a pager or buzzer for example. This is given to the patient at the time of registration in the hospital for example, or is attached to the patient for example as an armband. This pager or buzzer can fulfill similar functions to the described mobile device. In particular, it can advise the patient by a notification, e.g. by a visual and/or audible signal, when it is time to make for the service center. The position of the patient or his/her distance from the service center can be taken into account in said notification.

Thus, in addition to appointments scheduling, the central appointments scheduling system and/or the smartphone app can also be used for navigation, such as bidirectional navigation, in the hospital.

In another embodiment, the method according to the invention or the smartphone app is used for coordinating emergency medical response operations in order to control the capacity utilization of primary medical care institutions in a region. In such a scenario, the emergency response vehicles in each case possess a mobile device having a location tracking function and a message transmission function, in particular having a smartphone app. This enables the following steps to be performed:

A computer manages a central capacity utilization database for a number of primary medical care institutions, in particular emergency departments. Because in general no fixed appointments are assigned in primary care institutions of this type, no “appointments scheduling” is conducted in this case, but instead it is simply recorded in the central capacity utilization database which cases are currently being handled in each care institution in order to establish the utilization of capacity. In advantageous embodiment variants, the available medical equipment, premises and modalities, for example operating rooms, radiological equipment, etc., are also taken into account in this case. In an advantageous embodiment variant, the available medical staff can also be taken into consideration in order to determine the capacity utilization.

In the case of an emergency response operation, the paramedics enter an appointment request from their mobile device, which request is transmitted to the computer. The computer automatically detects the position of the emergency response vehicle through the use of the mobile device's location tracking function and communication of the position to the computer. From this, the computer calculates the expected travel times of the emergency response vehicle to at least one primary medical care institution. As a function of the current capacity utilization of the primary medical care institutions and the expected travel time(s) of the emergency response vehicle, the computer identifies a specific primary medical care institution to which the emergency response vehicle is to proceed, and forwards this information to the mobile device. If necessary, the urgency of the appointment can also be taken into account at the same time. If the appointment is a particularly urgent one, it is transmitted in any event to the nearest primary medical care institution. However, if the emergency is not quite so urgent, the utilization of capacity is taken into account, and the emergency response vehicle is directed to that primary medical care institution having the lowest capacity utilization.

The present invention also encompasses a non-transitory, computer-readable data storage medium and coded with programming instructions that, when the storage medium is loaded into a computer, caused the computer to implement any or all of the embodiments of the method according to the invention, as described above.

The following method for scheduling customer appointments is performed on the mobile device of the customer (and/or by the central appointments scheduling system or in cooperation with the latter):

The user is presented with a user interface on the mobile device, in particular the interface of a smartphone app. On said interface, the user can enter an appointment request, which is transmitted via the mobile communications network and/or internet to a central appointments scheduling system.

According to a preferred embodiment, the user also has the option to enter personal data and/or data relevant to the appointment, which data are forwarded to the central appointments scheduling system. This is particularly advantageous e.g. in the case of radiology appointments, in which the patients can already enter the data relevant to the registration via the smartphone app in advance of the appointment. Such data include age, gender, weight, for example, or also specific informed patient consent declarations. This information must otherwise be gathered by operators of the medical equipment during the appointment, which increases the duration of the appointment and reduces the utilization of the equipment's capacity.

After an appointment request has been entered by the user, the latter is offered a time window for an appointment, the time window being greater than the scheduled appointment duration. In addition, a fixed appointment may also be offered. The customer is requested to confirm the time window and/or the appointment. In another embodiment, if he/she does not confirm this, he/she is offered another time window and/or another appointment. In another embodiment, the customer may also be offered several time windows/appointments simultaneously, from which he/she may confirm one.

At the time of the appointment or of the time window extending to a point before the start time, the position of the customer's mobile device is forwarded to the central appointments scheduling system. This can be repeated at short, regular intervals (e.g. every 1-10 minutes) within the time window. If a late-show of the customer is indicated, for example by extrapolation of the expected travel time, the appointment is rescheduled e.g. automatically (or alternatively after confirmation of the determined location by the customer).

At the same time, the arranged available time window is available in order to pass on the customer in question to appointment slots that have become free at short notice. For this purpose, too, it is advantageous to know the position of the patient's mobile device so that the patient's possible travel time can be calculated. Thus, if an appointment is or becomes free within the time window, the mobile device receives a message with the offer to accept the free appointment. The user is provided a possibility via the smartphone app or the mobile device to confirm the offered appointment.

### BRIEF DESCRIPTION OF THE DRAWINGS

FIG. 1 is a schematic overview of a system in which the method according to the invention may be implemented.

FIG. 2 is a flowchart of an exemplary embodiment of the method according to the invention.

### DESCRIPTION OF THE PREFERRED EMBODIMENTS

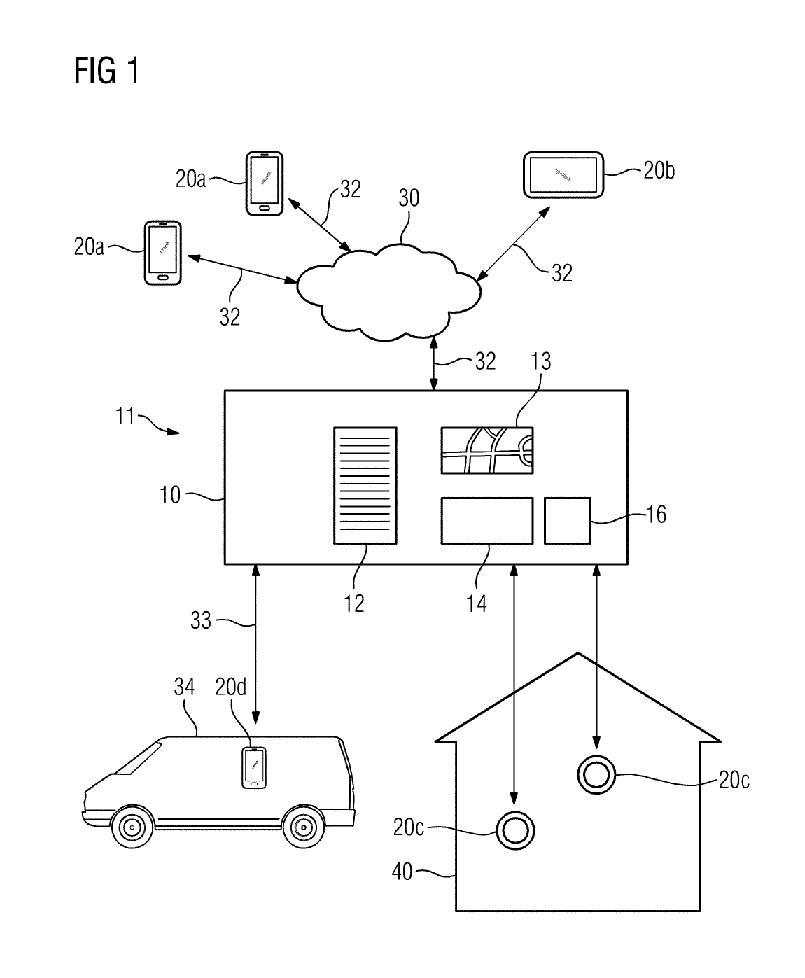

FIG. 1 shows a central computer 11 on which a central appointments scheduling system 10 for customer or, in this case, patient appointments is hosted.

Preferably, the method according to the invention is performed substantially automatically, though checks may be conducted at any time by operating staff, or also that individual appointments can be changed manually, in particular rescheduled, for example following telephone consultation.

The central appointments scheduling system has a computer program that administers an appointments database 12, i.e. an appointments diary, in which appointments are assigned on behalf of each service provider or, as the case may be, each physician or each device, e.g. in a radiological department or practice, i.e. time windows can be blocked for certain customers or patients or, as the case may be, provided e.g. with the above-cited status options. The appointments scheduling system 12 may preferably also include specific parameters for each appointment, for example the exact type of examination in the case of a radiological department. In the case of magnetic resonance examinations, it is advantageous for example to know in advance whether a knee, head or thorax examination is planned, since these examinations require different receive coils. Preferably, the appointments are assigned automatically such that examinations having the same parameters, i.e. requiring the same coils, are preferably scheduled to take place one after another.

In addition to the appointments database 12, the central appointments scheduling system may also include a computer unit 14, in particular a CPU, and a further data storage memory 16. The data storage memory 16 may be used e.g. for storing information sheets or films, which are forwarded to the patients for information purposes in advance of a scheduled examination.

In another embodiment, the central appointments scheduling system 10 furthermore has access to a route planner system 13 which is able to calculate the expected travel times of the patients from their communicated positions/locations. Particularly preferably, the route planner system 13 also takes the volume of traffic into account, such as Google Maps, for example. In some embodiment variants, the central appointments scheduling system 10 accesses Google Maps. In addition, the central appointments scheduling system 10 has an interface 32 to the internet 30, via which it communicates with the patients' mobile devices 20. Reference sign 20a in this case designates smartphones on which an app is installed which controls the communication and in particular the forwarding of the location of the smartphones to the central appointments scheduling system 10, in particular via the internet. Instead of a smartphone 20a, some patients will possibly use a tablet 20b. The method according to the invention can be implemented on any type of mobile device, including a watch, e.g. Apple Watch, or a laptop, as long as said device possesses a location tracking function and a message transmission function.

Appointment requests by patients can be forwarded via the internet connection 32 to the central appointments scheduling system 10, and the latter can suggest appointments. In particular, it will in each case propose an available time window, which in particular extends to a point before the actual appointment. Via the smartphone 20a, the patient can indicate in which time window he/she would be available for the appointment or the scheduled examination on the day in question or even on several days. Should the patient have been admitted to the hospital as an inpatient, the app may possibly also communicate the available times automatically. If the central appointments scheduling system has a free appointment at short notice, for example due to a default or a delay, it automatically detects the position of the mobile devices 20 of potentially suitable patients. Based on the distance to the service center 40, for example the radiological department in which the scheduled examination is to take place, a selection can be made of those patients who would be able to keep the appointment within the allotted timeframe. In this case the central appointments scheduling system 10 can either initially ask the patient that is nearest in terms of position. Preferably, the travel time is first calculated from the distance, in particular with the use of the route planner 18. If the travel time is shorter than the time remaining up to the start time of the free appointment and if, preferably, the examination scheduled for the new patient and the defaulted examination share the same parameters, for example the same receive coil is necessary therefor, a request is sent to the patient in question via the internet connection 32. The patient has the option, on his/her mobile device, in particular via a specific app, to accept or decline the appointment. If it is accepted, the central appointments scheduling system 10 moves the appointment of the second patient to the appointment slot that has become free.

The original appointment of the second patient is reallocated, by the above-described procedure, in order not to allow this appointment slot also to pass by unused. The patient whose appointment has been missed is offered a new appointment.

It is preferred that the central appointments scheduling system constantly polls the locations of the mobile devices 20 of the patients with pending appointments at short time intervals (e.g. every 1 to 10 minutes). In this way it can be detected automatically whether a patient will be late: from the position, the central appointments scheduling system 10 can calculate the expected travel time, and if this is greater than the time remaining to the start of the appointment, it can already identify a late-show for an appointment in advance. According to a preferred embodiment, the central appointments scheduling system 10 then sends a message via the internet 30 to the mobile device 20 in question to advise that the appointment will be delayed and asks the patient to confirm this. If the delay exceeds a certain minimum, the patient is informed that the appointment will not take place and the above-cited procedure is initiated in order to find a stand-in patient for this appointment and to book another appointment for the original patient.

In some embodiment variants, the central appointments scheduling system 10 is also responsible for controlling patient transport in the hospital. For this purpose, it is connected via a wireless or internet link 33 to a mobile device 20d of the transport service. The latter may make use of an ambulance 34 or else simply use mobile beds. Via the app on the mobile device 20b, the central appointments scheduling system 10 can propose a prioritization scheme to determine which patients are required to be transported first. In addition, the transport service is also informed about when the patient has to be collected again. In this way, unnecessary waiting times at the examination equipment, in particular MR scanners, are also kept to a minimum for the transport service; the entire patient flow in the hospital can be organized more efficiently.

According to a preferred embodiment, the appointments in the appointments scheduling system are not, or not exclusively, conducted at fixed times, but in the event of delay can also be moved in shorter time periods, for example using a minute-by-minute cycle. In this way, the central appointments scheduling system 10 can mirror actual events as accurately as possible—if an appointment has started 10 minutes late, for example, the system can automatically move the next appointment in this service center (or on this device or with this physician) back by 5 to 10 minutes as soon as this delay is predictable.

It is also possible to control the patient transport service in the hospital by means of the more precise timing cycle of the appointments scheduling system. In particular, the central appointments scheduling system 10 sends a message to the patient transport service at an appropriate time ahead of the respective appointment advising that the patient is to be collected from his/her room and brought to the service center, for example the radiology department. Similarly, the transport service is also notified in good time before the end of an appointment that the patient is once again to be collected from the service center and brought back to his/her ward. Preferably, the central appointments scheduling system in this case also takes into account the position of the mobile device 20d of the transport service. If the latter is a significant distance away, the system sends the notifications correspondingly earlier. The system can also control a plurality of patient transportation vehicles 34, in which case it can particularly advantageously take into account their respective locations, such that the patient transportation vehicle 34 having the shortest route is notified.

In a further preferred embodiment variant, upon arriving at the hospital 40, patients are issued with special mobile devices 20c which essentially assume a buzzer and/or pager function. However, they can also work as trackers, i.e. can communicate the respective location of the patient in the hospital to the central appointments scheduling system 10. The location can be determined by GPS and/or with the aid of the WLAN in the hospital 40. Thus, at regular intervals prior to a scheduled appointment of the respective patient, the central appointments management system 10 can determine the position of his/her mobile device or tracker 20c. If the appointment is so close that the patient needs to set off from his/her current location in order to arrive on time, a message can be transmitted to the mobile device, which attracts the patient's attention for example by means of an audible or visual signal (buzzer concept).

In another embodiment, the mobile devices 20c, like the devices 20a, 20b and 20d, can also be used for navigation, in particular for bidirectional navigation within the hospital. In this further functionality, the location of the service center or the radiology department/the MR scanner/the reception desk/the waiting area can be communicated to the patient by the central computer 11, and the patient can be navigated there if necessary. Conversely, the central appointments scheduling system 10 is informed about whether the patient is already in the hospital, and if so, where exactly. In this way, the patient can be navigated accordingly, with assistance also being sent if necessary in order to fetch him/her to the appointment. Above all, delays can be anticipated.

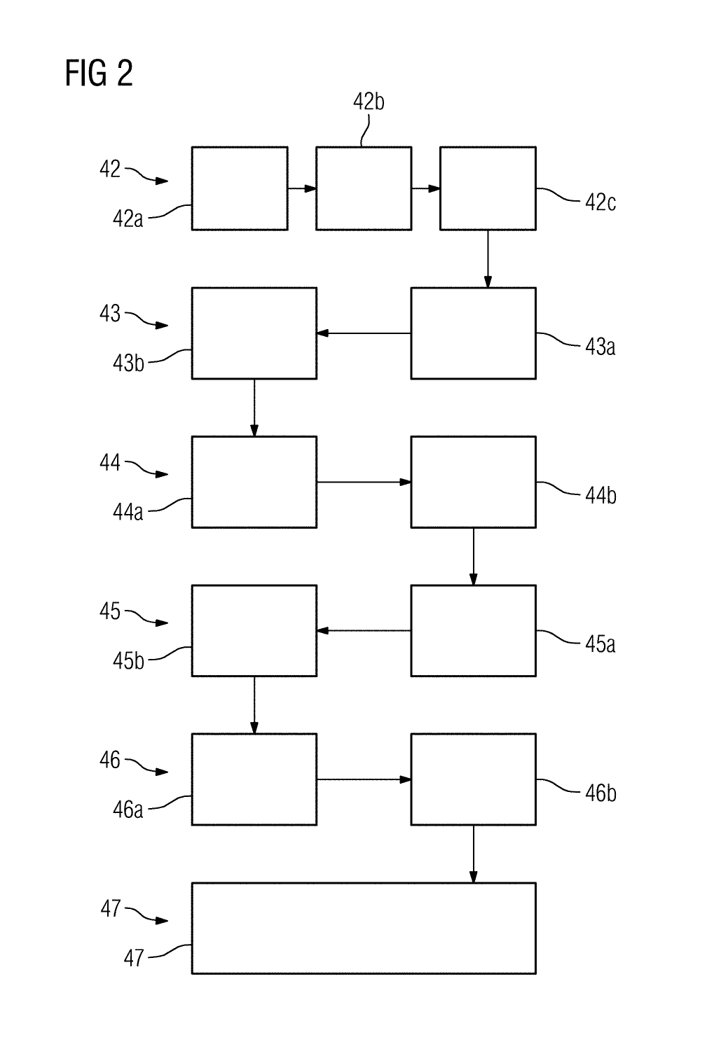

FIG. 2 shows an execution sequence of the exemplary method according to the invention, implemented on a smartphone app:

In step 42, an appointment is firstly arranged: the patient sends an appointment request 42a by message over the internet to the central appointments scheduling system 10. The latter proposes an appointment to the patient in step 42b, and the patient confirms this (42c). The central appointments scheduling system 10 thereupon asks the patient to indicate an available time window, which usually extends to a point before the arranged appointment and in which the patient is also available (step 43a). Once again by messaging over the internet—in the same way as this entire information exchange—the patient specifies such a time window in step 43b.

In step 44a, the patient is prompted to input personal data in preparation for the appointment (step 44b), e.g. his/her age, gender, weight, etc. This simplifies and shortens the time in the actual service center.

Once the available time window has been reached, it may be that another appointment becomes free, and this appointment is offered to the patient who is in possession of said smartphone in step 45. An appointment invitation is sent by messaging to the patient's smartphone 20a (45a) and the patient can confirm this (45b).

In step 46a, the position of the patient is then polled and communicated to the central appointments scheduling system 10 in order to check whether the patient is also able to keep the appointment. If necessary, a navigation aid is transmitted to the patient in step 46b to advise him/her of the quickest way to get to the examination center/service center.

When the patient reaches the service center, this can likewise be communicated to him/her by a message in step 47. A pass through the method according to the invention is accordingly terminated, and the patient can deactivate the app.

In another embodiment, the invention therefore provides a smartphone app for updating the scanner occupancy/appointments scheduling/navigation of the patient transport based on the patient's position determined via GPS and for anticipating delays.

The advantages reside in a better utilization of medical equipment/modalities, for example of radiological examination devices, in particular MR scanners. Furthermore, patient transport in the hospital is optimized. Patient waiting times are reduced and the patient is informed about a slot/appointment becoming free at short notice, and this is offered to him/her. The patient can therefore take advantage of an earlier appointment than actually scheduled and does not have to wait so long for his/her appointment.

With the method according to the invention, a smooth sequencing of examinations is ensured, without scheduling backlogs accumulating over the course of the day. Furthermore, administration overhead is reduced, since the patient can confirm the slot offered via app, and the scanner occupancy is updated automatically, advantageously without any intervention on the part of staff.

Furthermore, the capacity utilization of the scanner suites or service centers can also be optimized in that patients may possibly also be offered appointments in other service centers (e.g. in the case of radiological practices having several branches in a region).

Although modifications and changes may be suggested by those skilled in the art, it is the intention of the Applicant to embody within the patent warranted hereon all changes and modifications as reasonably and properly come within the scope of the Applicant's contribution to the art.

1. A computer-implemented method for scheduling customer appointments in one or more service centers, wherein at least some of the customers possess a mobile device having a location tracking function and a message transmission function, said method comprising:
a) managing a central appointments scheduling system for customer appointments in a computer, wherein the customer appointments in each case have a start time and an appointment duration, and wherein the appointments scheduling system has assigned at least one customer an available time window in which the customer is available for an appointment;
b) recording a default on or delay to a customer appointment of a first customer, in particular due to a late-show or no-show of the first customer;
c) detecting the position of at least one second customer whose available time window overlaps with the defaulted customer appointment through the use of the location tracking function of the mobile device and communication of the position to the central appointments scheduling system;
d) calculating the expected travel time of the second customer to the service center (40) in which the defaulted appointment was to take place from the position of the second customer and, if the travel time is shorter than the time remaining up to the start time of the defaulted appointment, sending a message to the second customer with the offer to accept the defaulted appointment; and
e) upon a confirmation of the offer by the second customer, assigning the defaulted appointment to the second customer.

2. The method as claimed in claim 1, wherein registering a default on or delay to the customer appointment of the first customer comprises:
determining the position of the first customer through the use of the location tracking function of the mobile device and communication of the position to the central appointments scheduling system;
calculating the expected travel time of the first customer to the service center in which the customer appointment is to take place; and
comparing the expected travel time with the time remaining up to the start time of the customer appointment.

3. The method as claimed in claim 1, comprising performing (b) to (e) automatically prior to each customer appointment.

4. The method as claimed in claim 1, comprising arranging the customer appointments in order in the central appointments scheduling system according to specific parameters, and performing (c) to (e) only or firstly for second customers whose scheduled appointments satisfy the ordering parameters.

5. The method as claimed in claim 1, comprising, in the central appointments scheduling system, managing the appointments of a plurality of service centers, wherein at least some customer appointments can optionally take place either in a first service center or in a second service center of said plurality of service centers.

6. The method as claimed in claim 1, comprising, in said computer, immediately before each customer appointment, determining the position of the customer in question and, based on the position, sending the customer directions to the service center in which the appointment is to take place.

7. The method as claimed in claim 1, wherein the mobile device is a smartphone, a tablet computer, a notebook or a pager.

8. A computer-implemented method for coordinating emergency response vehicles and a plurality of primary medical care institutions, wherein the emergency response vehicles in each case possess a mobile device having a location tracking function and a message transmission function, said method comprising:
with a computer, managing a central capacity utilization database for a plurality of primary medical care institutions;
in said computer, recording an appointment request for primary medical care transmitted by a mobile device of an emergency response vehicle;
in said computer, automatically detecting the position of the emergency response vehicle through the use of the location tracking function of the mobile device with communication of the position to the computer;
in said computer, calculating the expected travel times of the emergency response vehicle to the plurality of primary medical care institutions; and
in said computer, identifying, as a function of the current capacity utilization of the primary medical care institutions and the expected travel times of the emergency response vehicle to the primary medical care institutions, a primary medical care institution and forwarding said information to the mobile device of the emergency response vehicle.

9. A method for scheduling customer appointments in one or more service centers, said method being performed on a mobile device having a location tracking function and a message transmission function, in particular by an application stored in and executed by said mobile device, said method comprising:
presenting a user interface on the mobile device;
entering an appointment request by the user, and forwarding the appointment request to a central appointments scheduling system;
via the mobile device, offering a time window for an appointment, wherein the time window is greater than the scheduled duration of the appointment;
at an input interface at the mobile device, providing a display element for the user to confirm the time window;
within the time window, communicating the position of the mobile device to the central appointments scheduling system;
if an appointment is free within the time window, receiving a message to the mobile device with the offer to accept the free appointment;
at said input interface of the mobile device, providing another display element for the user to confirm the offered appointment.

10. The method as claimed in claim 11, comprising, providing, at said input interface of said mobile device, a display field for the user to enter personal data and/or data relevant to the appointment, and forwarding said data forwarded to the central appointments scheduling system.
